(19) United States
(12) Patent Application Publication
(10) Pub. No.: US 2024/0421406 A1
(43) Pub. Date: Dec. 19, 2024

(54) DEVICES SYSTEMS AND METHODS FOR VEHICLE POWER STORAGE

(71) Applicant: VOLKSWAGEN AKTIENGESELLSCHAFT, WOLFSBURG (DE)

(72) Inventors: Benno ANDREAS-SCHOTT, Signal Mountain, TN (US); Ulrich MAEHR, Redwood City, CA (US)

(21) Appl. No.: 18/209,845

(22) Filed: Jun. 14, 2023

(51) Int. Cl. H01M 50/249; H01M 10/625; H01M 10/6556; H01M 50/204; H01M 50/26

(52) U.S. Cl. CPC H01M 50/249; H01M 10/625; H01M 10/6556; H01M 50/204; H01M 50/26; H01M 50/502; H01M 2220/20

(57) ABSTRACT

Devices, systems, and methods concerning vehicle modular power storage can include a number of power storage modules comprising power storage materials, each power storage module including a housing defining a power storage cavity therein for receiving power storage materials, the housing including a casing defining a fluid passageway through the housing, the fluid passageway being separate from the power storage cavity and formed to pass fluid coolant in thermal communication to receive heat from the housing.

### FIELD

The present disclosure relates to devices, systems, and methodologies for vehicle power storage. More particularly, the present disclosure relates to devices, systems, and methodologies for vehicle power storage and arrangements related to vehicle power storage.

### BACKGROUND

Transportation vehicles, such as cars, trucks, and buses, are increasing electric power needs, including for motive energy. Advances in power storage systems, such as chemical battery systems can face additional challenges to safely and/or effectively storage power for vehicle use. Additionally, changes in the vehicle power storage requirements can drive further need for economical designs for vehicle power storage.

### SUMMARY

According to an aspect of the present disclosure, a modular vehicle power storage system may include a number of power storage modules comprising power storage materials. Each power storage module may include a housing defining a power storage cavity therein for receiving power storage materials. The housing may include a casing and a cap. The casing may include an inner wall and an outer wall spaced apart from each other to define the power storage cavity therebetween. The cap may be formed for engagement with the casing between the inner and outer walls to enclose the power storage cavity with the power storage materials therein. The casing may define a fluid passageway through the housing, the fluid passageway being separate from the power storage cavity and formed to pass fluid coolant in thermal communication to receive heat from the housing. In some embodiments, the cap may be formed distinctly from the casing, allowing access to the power storage cavity.

In some embodiments, the module connector may extend from the housing for engagement with an adjacent power storage module. The modular connector may define an extended portion of the fluid passageway to pass fluid coolant with the adjacent power storage module. The housing may define a connector receptacle for receiving connection of the module connector of an adjacent power storage module. In some embodiments, the connector receptacle may define an opening of the fluid passageway such that fluid coolant passing through the modular connector of the adjacent power storage module engaged with the connector receptacle passes through the fluid passageway via the opening.

In some embodiments, the housing may define a connector receptacle for receiving connection of the module connector of an adjacent power storage module. The module connector may define a nozzle for engagement with the connector receptacle of an adjacent power storage module to fluidly seal therebetween. In some embodiments, at least one of the nozzle and the connector receptacle of the adjacent power storage module may include a seal receiver for holding a seal for engagement between the nozzle and the connector receptacle to form a fluid seal. In some embodiments, the module connector may define a shoulder for engagement with an end of the connector receptacle of the adjacent power storage module while the nozzle is received therein, to define a gap between the power storage module and the adjacent power storage module.

In some embodiments, a plurality of the power storage modules may be arranged laterally adjacent each other in an initial course. The laterally adjacent modules may be electrically connected between anodes and between cathodes. In some embodiments, another plurality of the power storage modules may be arranged laterally adjacent each other in another course, wherein each of the power storage modules of the other course are engaged with a corresponding power storage module of the initial course such that the module connector of each of the power storage modules of one of the initial course and the other course is engaged with the connector receptacle of the corresponding power storage module of the other one of the initial course and the other course.

In some embodiments, the corresponding power storage modules of the initial and other courses may collectively define fluid coolant channels by communication of their fluid passageways. The system may further include a manifold for communication with the coolant channels to pass fluid coolant.

In some embodiments, the system may further include a cooling heat exchanger in communication with the manifold to receive warm fluid coolant for cooling and returning to the courses of power storage modules. In some embodiments, a vehicle may comprising the modular vehicle power storage system(s) as previously mentioned.

According to another aspect of the present disclosure, a vehicle power storage module may include a housing defining a power storage cavity therein for receiving power storage materials. The housing may include a casing and a cap. The casing may include an inner wall and an outer wall spaced apart from each other to define the power storage cavity therebetween. The cap may be formed for engagement with the casing between the inner and outer walls to enclose the power storage cavity with the power storage materials. The casing may define a fluid passageway through the housing, the fluid passageway being separate from the power storage cavity and formed to pass fluid coolant in thermal communication to receive heat from the housing. In some embodiments, the cap may be formed distinctly from the casing, allow access to the power storage cavity.

In some embodiments, a module connector may extend from the housing for engagement with an adjacent power storage module. The modular connector may define an extended portion of the fluid passageway to pass fluid coolant with the adjacent power storage module. The housing may define a connector receptacle for receiving connection of the module connector of an adjacent power storage module.

In some embodiments, the casing may be uniformly formed as a canister having the outer wall and the inner wall defined from the same sheet of material. The inner wall may integrally define at least one of the fluid passageway, the connector receptacle, and the module connector. In some embodiments, the cap may be annularly shaped around at least a portion of the fluid passage.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a vehicle having a modular vehicle power storage system indicated in broken line, in accordance with disclosed embodiments;

FIG. 2 is a diagrammatic view of the modular vehicle power storage system of FIG. 1 showing that the modular vehicle power storage system includes courses of power storage modules, and indicating a flow of fluid coolant for cooling the modules, in accordance with disclosed embodiments;

FIG. 3 is a plan view of a course of power storage modules of the modular vehicle power storage system of FIGS. 1 & 2 showing electrical connection across anodes and cathodes, respectively, in accordance with disclosed embodiments;

FIG. 4 is a perspective view of a power storage module of the modular vehicle power storage system of FIGS. 1-3 showing a housing and a module connector thereof for engagement with an adjacent power storage module, and a fluid passageway defined therein for passing fluid coolant between adjacent power storage modules, in accordance with disclosed embodiments; and

FIG. 5 is a cross-sectional view of the power storage module taken along the plane 5-5 of FIG. 4, showing that the housing defines a storage cavity for power storage materials, and showing that a casing defines the module connector having the fluid passageway therethrough for engagement with an adjacent power storage module, in accordance with disclosed embodiments.

### DETAILED DESCRIPTION OF THE DISCLOSED EMBODIMENTS

Increasing electrical power needs in vehicles, whether by increases in electronic devices and/or the use of electric motive power in electric-powered vehicles (EVs) which use electricity for motive power whether wholly or partially as a hybrid vehicle, often requires robust on-board power storage. Whether combined with other power sources, such as combustion engines or fuel-cells, or implemented alone, on-board chemical battery storage can provide reliable electric power for transportation vehicles. However, such on-board power storage applications can often raise complexity, cost, and/or infrastructure requirements to support their implementation.

For example, more robust power storage devices can generate significant heat loads. Moreover, today's vehicles can face challenges in reducing the time for charging, for example, to charge a Li-Ion battery in less than 30 minutes. Rapid charging can require particularly high currents, which can result in significant heat generation. Cooling of the power storage modules can assist in managing those heat loads, and/or can relocate the heat generated to particular solutions of the vehicle, reducing the potential for excessive heat build-up. Accordingly, advances in cooling techniques can assist in reducing the effects of such heat generation, including further negative heat effects concerning material in-homogeneities and/or other damages.

Additionally, modularization of power storage can assist in allowing repair or partial replacement of modules. Such modular design can avoid the need for costly replacement of large power storage devices. However, modularization can face the need for structural support to reinforcement individual modules.

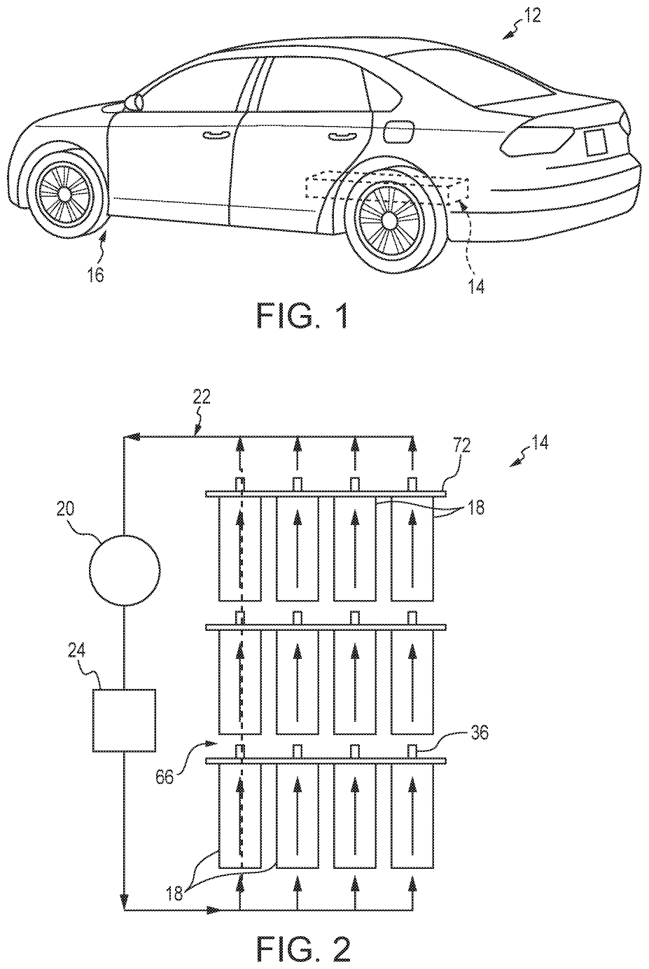

As suggested in FIG. 1, a transportation vehicle 12 is shown including a modular vehicle power storage system 14. The modular vehicle power storage system 14 is illustratively embodied as a primary chemical battery storage system providing motive power to the drive train of the vehicle 12 and also to electronics and other vehicle sub-systems, and receiving charging via alternator, regenerative braking, and/or via plug-in charging; although in some embodiments, only partial or no motive vehicle power may be provided by the power storage system.

The vehicle 12 includes a chassis 16 including frame and body, supported on wheels engaged with the ground surface, and configured to provide motive power to the wheels, illustratively via electrically-drive wheel motors (and in some embodiments, may be configured to receive motive power via the wheels for charging via regenerative braking). The vehicle 12 illustratively includes additional supporting components, including a processor for executing instructions stored on memory storage, and communication circuitry for conducting vehicle activities, including battery management activities.

Referring now to FIG. 2, the vehicle power storage system 14 is shown having several courses or layers of vertically separated power storage modules 18. As discussed in additional detail herein, the modules 18 are connected with corresponding modules (vertically in the illustrated orientation of FIG. 2, separated for illustration) such that the courses are connected together in a modularized unit.

In the illustrative embodiment as suggested in FIG. 2, the courses are stacked such that fluid coolant can be passed between the corresponding modules 18. The fluid coolant can be pumped via pump 20 through a manifold 22 and through a heat exchanger 24 for cooling the fluid coolant. Accordingly, a coolant system can circulate fluid coolant to reject heat from the modular vehicle power storage system 14.

The heat exchanger 24 may be a radiator or other cooling exchanger of the vehicle. As discussed in additional detail herein, flow paths can be designed into the infrastructure of the modules to pass fluid coolant through each module 18 to enhance heat rejection overall. Although shown with vertical stacking, in some embodiments, courses of modules 18 can be arranged in any suitable position.

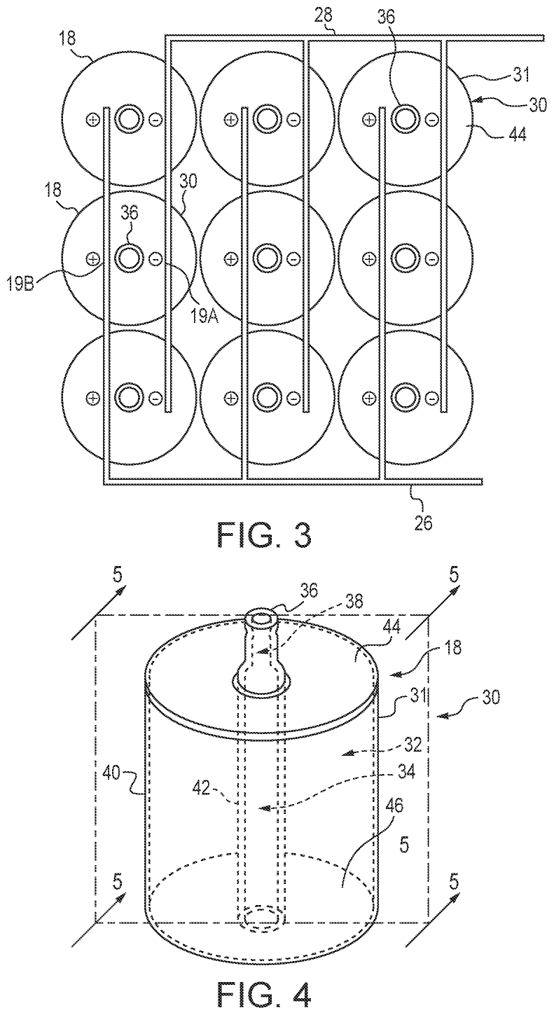

Referring to FIG. 3, a course of modules 18 is shown from overhead. In the illustrative embodiment, the modules 18 are shown as cylindrically shaped, as canisters, although any suitable shape maybe applied in some embodiments. Each module 18 includes cathode 19A and anode 19B terminals as negative and positive voltage contacts, respectively.

Each cathode and anode terminal is illustratively connected with a respectively positive bus bar 26 and negative bus bar 28 in FIG. 3. The bus bars 26, 28 can be connected with other courses of corresponding polarity to provide the desired output power specifications. For example, as shown in FIG. 3, multiple modules 18 of the same course are connected in parallel to provide greater amperage at the same voltage level for an individual module 18. Although in some embodiments, any suitable electrical arrangement of modules may be applied.

Referring now to FIG. 4, a power storage module 18 is shown including a housing 30. The housing 30 is illustratively formed as a canister and defines a power storage cavity 32 therein. The power storage cavity 32 is illustratively formed to receive power storage materials, including positive and negative electrodes bathed in electrolyte fluids, as discussed in additional detail herein. A fluid passageway 34 is defined through the housing 30 for passing fluid coolant in thermal communication with the housing 30.

In the illustrative embodiment, the housing 30 includes a module connector 36 extending therefrom for engagement with a corresponding adjacent power storage module 18 as suggested concerning FIG. 2. The module connector 36 illustratively defines an extended portion 38 of the fluid passageway 34 for flowing fluid coolant between modules 18.

The housing 30 includes a casing 31 having an outer wall 40 and inner wall 42 that are spaced apart from each other to define the power storage cavity 32 therebetween. The fluid passageway 34 is defined by the inner wall 42 providing separation from the power storage cavity 32. The housing 30 includes a cap 44 and a bottom 46 (of casing 31) each extending between the walls 40, 42 to collectively enclose the power storage cavity 32. In the illustrative embodiment, the cap 44 is formed separately from the walls 40, 42 and bottom 46, which are intergrated together, to allow the cap 44 to be affixed once the power storage cavity 32 is sufficiently accessed.

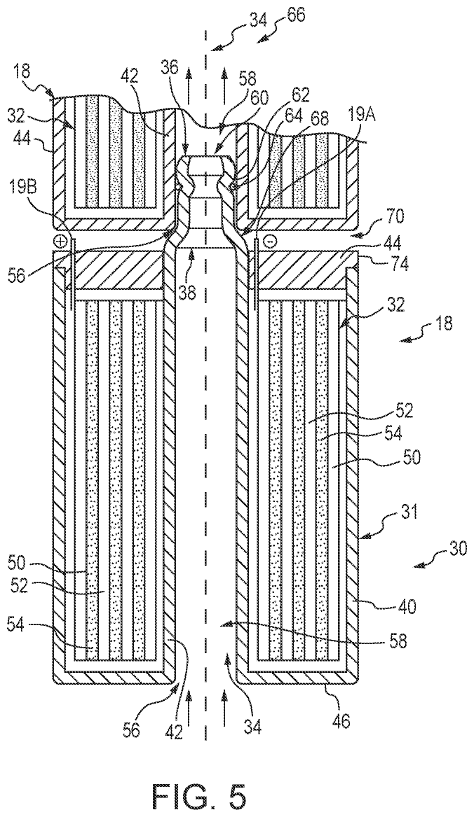

Referring now to FIG. 5, the power storage materials can be seen arranged within the power storage cavity 32. In the illustrative embodiment, the power storage materials are formed as a jelly roll architecture, in which sheets of negative (50) and positive (52) electrode materials are alternated in a stack with each electrode sheet separated from the next electrode sheet by a separator sheet (54). The layers of sheets are generally rolled up into a cylinder, maintaining their alternating arrangement, and inserted into the power storage cavity surrounding the inner wall 44, and between the radially spaced walls 42, 44, as suggested in FIG. 5. Insulator materials may be arranged at the top and/or bottom of the roll of layers. Each of the cathode 19A and anode 19B terminals include an electrical connection extending into the power storage cavity 32 through the housing 30 in electrical communication with their respective sheets 50, 52.

The module connector 36 is formed for engagement with the adjacent power storage module 18. As shown in FIG. 5, the module connector 36 extends into the adjacent power storage module 18 (shown as the upper adjacent power storage module 18 in the orientation of FIG. 5) by insertion through an opening 56 of the fluid passageway 34 of the adjacent power storage module 18. Casing 31 defines a receptacle 58 via wall 42, and the receptacle 58 defines the opening 56, for conforming engagement with the module connector 36 of the adjacent module 18.

Still referring to the illustrative embodiment as shown in FIG. 5, the module connector 36 is formed as a nozzle for communication of fluid coolant between corresponding modules 18. The module connector 36 extends into the adjacent module 18 to an outlet end 60, and is illustratively tapered near the end 60 to facilitate case in connection.

The module connector 36 illustratively includes a seal receiver 62 defined as a depression in the wall of the module connector 36 formed to hold a seal 64. The seal 64 is illustratively embodied as a seal ring extending circumferentially about the module connector 36 and engaged between each of the module 18 and adjacent module 18. As shown in FIG. 5, the seal 64 illustratively engages between the nozzle 36 and the connector receptacle 58 of the adjacent power storage module 18 to form a fluid seal. In some embodiments, a seal receiver may be defined by the connector receptacle 58.

Accordingly, the fluid passageways 34 of the corresponding modules 18 are arranged in communication with each other to define a fluid coolant channel 66. As suggested above, fluid coolant can be circulated through the fluid coolant channels 66 defined by various course of modules 18 to provide cooling via network integrated within the architecture of the modules 18.

Still referring to the illustrative embodiment as shown in FIG. 5, the module connector 36 illustratively includes a shoulder 68. The shoulder 68 is illustratively embodied as a stepped portion of the wall of the module connector 36, defining a larger radial portion, such that the adjacent power storage module 18 (upper module 18, in the orientation of FIG. 5) engages the shoulder 68 by its bottom end.

The engagement between the adjacent module 18 and the shoulder 68 illustratively defines a gap 70 between the corresponding modules 18 when engaged together. The gap 70 can provide space for connection between modules 18 of the same course. For example, referring briefly to FIG. 2, in some embodiments, each course of modules 18 may include bracing 72 to provide mechanical coupling between neighboring modules 18 of the same course to promote strength of assembly and/or ease in handling. Moreover, as suggested in FIG. 3, electrical connection between terminals 19A, 19B of the modules 18 within a course can be facilitated by cabling extending within the gap 70.

As suggested in FIG. 5, the module connector 36 is illustratively defined by the inner wall 42 in situ. Such arrangements can provide simplicity and/or cost reduction in manufacturing, for example by blow molding implementation. In some embodiments, the mechanical connection via module connector can provide stability between the courses of modules, while facilitating a cooling network.

In the illustrative embodiment as shown in FIG. 5, the cap 44 is formed distinctly from the casing 31 for engagement therewith. The power storage cavity 32 can thus be accessed with the cap 44 apart from the casing 31 for access, including for example, to allow placement of power storage materials within the power storage cavity 32. The cap 44 extends between the walls 40, 42 to engage therewith and enclose the power storage cavity 32.

As mentioned above, the power storage materials are generally bathed in electrolyte fluids within the power storage cavity 32 to promote their electrical-chemical activities. The cap 44 illustratively completes the fluid tight power storage cavity 32. In the illustrative embodiment, the cap 44 engages the walls 40, 42 on their interior sides relative to the power storage cavity 32. The cap 44 illustratively includes a lip 74 extending across the upper end (in the orientation as shown in FIG. 5) of the outer wall 40.

The cap 44 is illustratively formed to extend circumferentially about the opening to the power storage cavity 32 defined by the casing 31 to enclose the cavity 32. As the module connector 36 extends from the casing 31, the cap 44 extends circumferentially about the module connector 36 when engaged with the casing 31. The module connector 36, and/or at least the inner wall 42 which extends to define the module connector 36, projects through an opening in the cap 44 for engagement with the corresponding module 18 of the adjacent course. In some embodiments, the cap 44 may be engaged with the casing 31 in removable manner to allow access to the cavity 32, for example, for maintenance activities.

As mentioned above, components for battery operation can include computer-implemented battery management systems having processors executing instructions to support such activities. Examples of suitable processors may include microprocessors. Examples of suitable processors may include one or more microprocessors, integrated circuits, system-on-a-chips (SoC), among others. Examples of suitable memory, may include one or more primary storage and/or non-primary storage (e.g., secondary, tertiary, etc. storage); permanent, semi-permanent, and/or temporary storage; and/or memory storage devices including but not limited to hard drives (e.g., magnetic, solid state), optical discs (e.g., CD-ROM, DVD-ROM), RAM (e.g., DRAM, SRAM, DRDRAM), ROM (e.g., PROM, EPROM, EEPROM, Flash EEPROM), volatile, and/or non-volatile memory; among others. Communication circuitry may include components for facilitating processor operations, for example, suitable components may include transmitters, receivers, modulators, demodulators, filters, modems, analog/digital (AD or DA) converters, diodes, switches, operational amplifiers, and/or integrated circuits.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure, the protected scope of which is defined by the claims.

What is claimed is:

1. A modular vehicle power storage system, comprising:
a number of power storage modules comprising power storage materials,
each power storage module including a housing defining a power storage cavity therein for receiving power storage materials, the housing including a casing and a cap, the casing including an inner wall and an outer wall spaced apart from each other to define the power storage cavity therebetween, the cap formed for engagement with the casing between the inner and outer walls to enclose the power storage cavity with the power storage materials therein,
wherein the casing defines a fluid passageway through the housing, the fluid passageway being separate from the power storage cavity and formed to pass fluid coolant in thermal communication to receive heat from the housing.

2. The modular vehicle power storage system of claim 1, wherein a module connector extends from the housing for engagement with an adjacent power storage module.

3. The modular vehicle power storage system of claim 2, wherein the modular connector defines an extended portion of the fluid passageway to pass fluid coolant with the adjacent power storage module.

4. The modular vehicle power storage system of claim 3, wherein the housing defines a connector receptacle for receiving connection of the module connector of an adjacent power storage module.

5. The modular vehicle power storage system of claim 4, wherein the connector receptacle defines an opening of the fluid passageway such that fluid coolant passing through the modular connector of the adjacent power storage module engaged with the connector receptacle passes through the fluid passageway via the opening.

6. The modular vehicle power storage system of claim 2, wherein the housing defines a connector receptacle for receiving connection of the module connector of an adjacent power storage module.

7. The modular vehicle power storage system of claim 6, wherein the module connector defines a nozzle for engagement with the connector receptacle of an adjacent power storage module to fluidly seal therebetween.

8. The modular vehicle power storage system of claim 7, wherein at least one of the nozzle and the connector receptacle of the adjacent power storage module includes a seal receiver for holding a seal for engagement between the nozzle and the connector receptacle to form a fluid seal.

9. The modular vehicle power storage system of claim 7, wherein the module connector defines a shoulder for engagement with an end of the connector receptacle of the adjacent power storage module while the nozzle is received therein, to define a gap between the power storage module and the adjacent power storage module.

10. The modular vehicle power storage system of claim 1, wherein a plurality of the power storage modules are arranged laterally adjacent each other in an initial course, and electrically connected between anodes and between cathodes.

11. The modular vehicle power storage system of claim 10, wherein another plurality of the power storage modules are arranged laterally adjacent each other in another course, wherein each of the power storage modules of the other course are engaged with a corresponding power storage module of the initial course such that the module connector of each of the power storage modules of one of the initial course and the other course is engaged with the connector receptacle of the corresponding power storage module of the other one of the initial course and the other course.

12. The modular vehicle power storage system of claim 11, wherein the corresponding power storage modules of the initial and other courses collectively define fluid coolant channels by communication of their fluid passageways, and the system further comprises a manifold for communication with the coolant channels to pass fluid coolant.

13. The modular vehicle power storage system of claim 12, further comprising a cooling heat exchanger in communication with the manifold to receive warm fluid coolant for cooling and returning to the courses of power storage modules.

14. A vehicle comprising the modular vehicle power storage system of claim 1.

15. A vehicle power storage module, comprising:
a housing defining a power storage cavity therein for receiving power storage materials, the housing including a casing and a cap, the casing including an inner wall and an outer wall spaced apart from each other to define the power storage cavity therebetween, the cap formed for engagement with the casing between the inner and outer walls to enclose the power storage cavity with the power storage materials,
wherein the casing defines a fluid passageway through the housing, the fluid passageway being separate from the power storage cavity and formed to pass fluid coolant in thermal communication to receive heat from the housing.

16. The vehicle power storage module of claim 15, wherein a module connector extends from the housing for engagement with an adjacent power storage module.

17. The vehicle power storage module of claim 16, wherein the modular connector defines an extended portion of the fluid passageway to pass fluid coolant with the adjacent power storage module.

18. The vehicle power storage module of claim 17, wherein the housing defines a connector receptacle for receiving connection of the module connector of an adjacent power storage module.

19. The vehicle power storage module of claim 18, wherein the casing is uniformly formed as a canister having the outer wall and the inner wall defined from the same sheet of material, and the inner wall integrally defining the fluid passageway, the connector receptacle, and the module connector.

20. The vehicle power storage module of claim 19, wherein the cap is annularly shaped around at least a portion of the fluid passage.
